(19) United States
(12) Patent Application Publication
(10) Pub. No.: US 2011/0190033 A1
(43) Pub. Date: Aug. 4, 2011

(54) METHOD FOR MASKING MOBILE PHONE MESSAGES FROM THE SIGHT OF OTHER PEOPLE

(75) Inventor: Ma Tianshu, Beijing (CN)

(73) Assignee: Gemalto SA, Meudon (FR)

(21) Appl. No.: 12/738,793

(22) PCT Filed: Oct. 17, 2008
(86) PCT No.: PCT/EP2008/064015

§ 371 Date: Jul. 20, 2010

(30) Foreign Application Priority Data
Oct. 17, 2007 (CN) 200710306185.9

(51) Int. Cl. H04W 88/02

(52) U.S. Cl. 455/566

(57) ABSTRACT

The invention relates to a mobile terminal assembly (10, 20) in a mobile communication network, said mobile terminal assembly (10, 20) comprising a processor and a memory and hosting software which controls, after an original message has been received, the following steps: d) display on the mobile terminal assembly (10, 20) a pre-defined content which the end-user previously knows as meaning that a PIN code is expected, e) expect input of a PIN code, and, f) allow access to content of the original message when the end-user has input the expected PIN code.

The invention relates to mobile telephony networks and in particular to such networks when carrying text messages such as SMS—short message service—or e-mails. The invention may apply for example to CDMA networks or third generation of mobile telephony networks. The invention is not limited to mobile phones, it applies also to networks enabled for carrying messages to mobile terminals, such mobile terminals being likely to be solely data receivers and possibly data senders.

The invention deals in particular to such networks when end-user terminals host a security personal token allowing access of the end-user to the network by authentication of the end-user thereby protecting his personal account from non-authorized charge thereof by fraud of others. Such personal tokens may be called subscriber identity modules, and may be embodied as smart cards.

The content of a short message is usually displayed by an end-user actuating a “VIEW” button on his mobile terminal. The short message then appears on the screen of the mobile terminal. At this specific stage, the end-user may note that the short message has a private or a confidential aspect but it may be too late for him to hide it to others because the people just nearby tend to glance at the screen simultaneously as the end-user and read with him the message. Examples of such a situation may be when the end-user receives update information about his personal life, such as bank account amount, messages pertaining to his sentimental life, or update about legal disputes he may have.

With current SMS schemes, another problem is that anybody may be tempted, after noticing that some message has arrived on the phone of the end-user, to fraudulently or in good faith read his arrived message and may thereby arrive onto private aspects of the life of the end-user, or access to some sensitive data, which raises the same issue as in the preceding situation.

The invention aims at helping an end-user of a terminal in a mobile network avoid that a incoming message may be seen by some other people that are around him or that have access to his mobile terminal.

This goal is achieved by means of the invention as recited in the appended claims.

Other aspects, features and benefits of the invention will appear through the following description, which is made in reference to the drawings, among which:

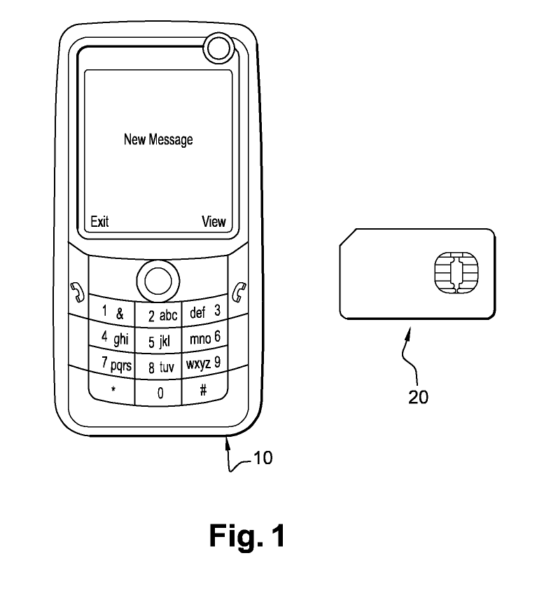

FIG. 1 depict a mobile terminal assembly according to an embodiment of the invention;

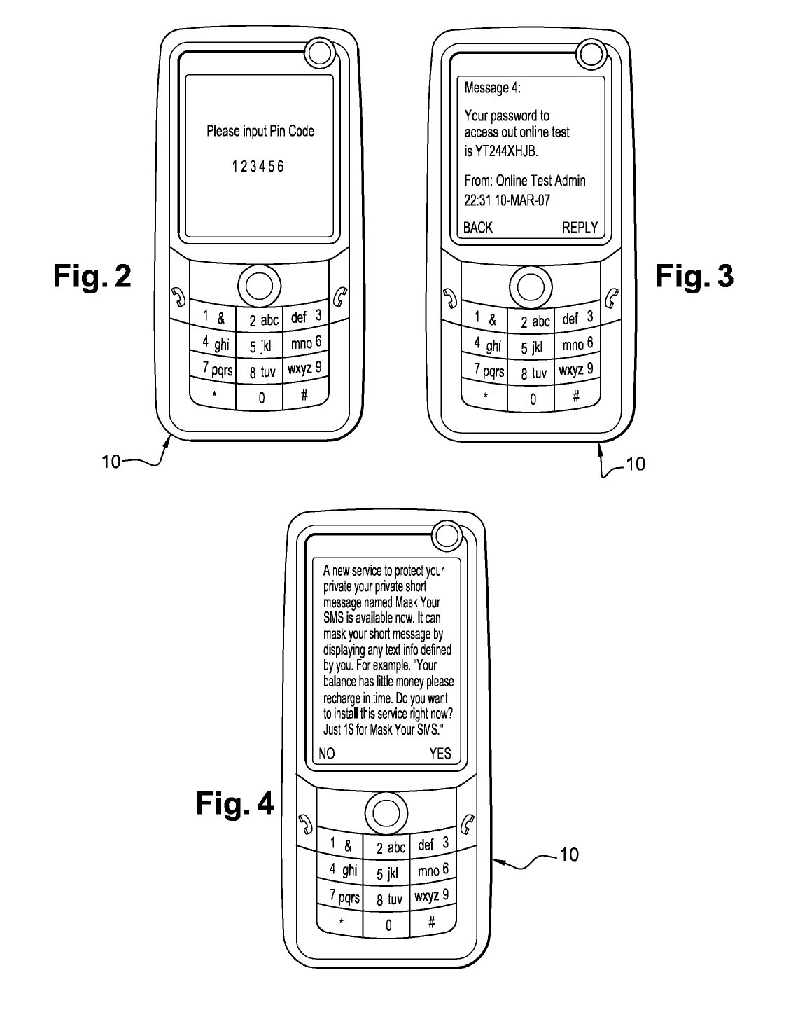

FIG. 2 depicts the mobile terminal assembly at a PIN code input step;

FIG. 3 depicts the mobile terminal assembly at an original message displaying step;

FIG. 4 depicts the mobile terminal assembly at a service presenting step;

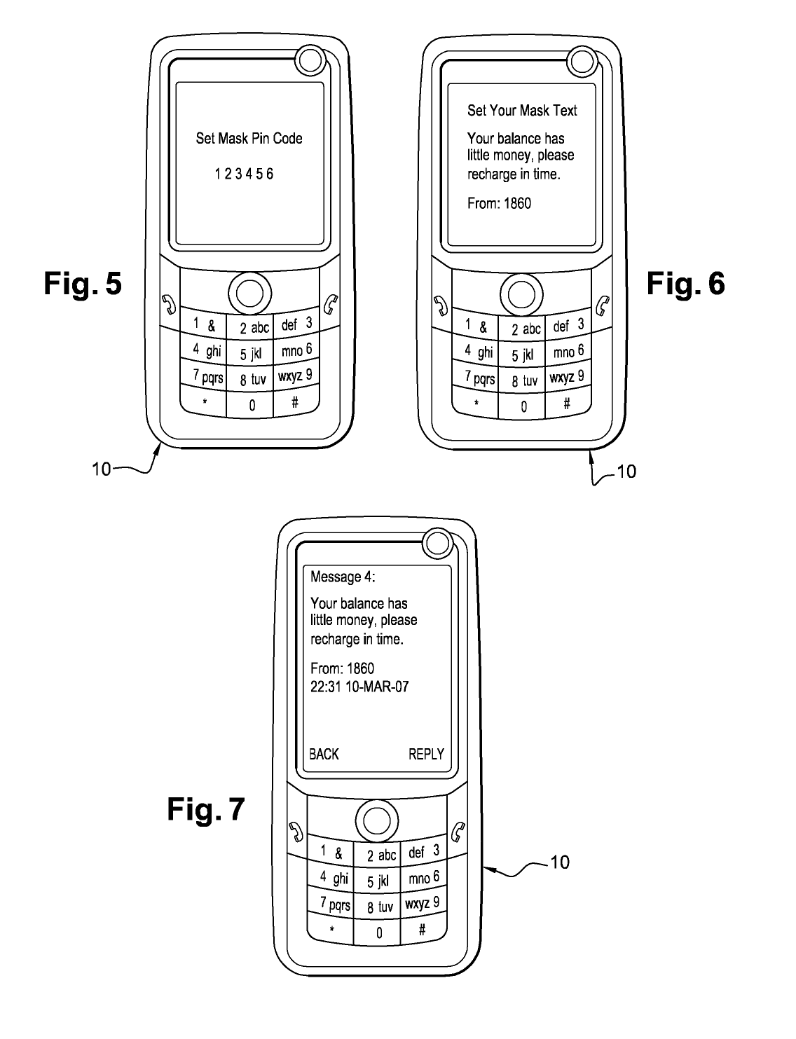

FIG. 5 depicts the mobile terminal assembly at a PIN code setting step;

FIG. 6 depicts the mobile terminal assembly at a mask text setting step;

FIG. 7 depicts the mobile terminal assembly at a mask text displaying step.

A preferred embodiment of the invention will here-after be described, in which an incoming message is protected from being viewed by other people than the recipient end-user. For this purpose, the incoming message is protected by a password or PIN code that the end-user has to type on the mobile phone for launching the display of the incoming message.

On FIG. 1, a mobile phone is represented under reference 10, which hosts a SIM card 20. SIM card 20 comprises a microprocessor and a memory. In the present case, the incoming message is a SMS which, in compliance to the mobile telephony standards, is stored in the memory of the SIM card 20 as soon as received.

In the present embodiment, the received SMS can be displayed on the screen of the mobile phone 10 only after the end-user has typed his PIN code. For this purpose, a Java application is stored and run in the SIM card 20, which proposes access to the received messages and, in case of wished access to the received messages, requires the holder of the mobile phone to type the expected PIN code. In case the typed PIN code is not the expected one, access to the received message is denied. Whenever the end-user wants to view the original content, what he needs to do is just to input pin code correctly.

The Java application can be loaded and installed over-the-air to an entire float of existing users' SIM cards in the network.

This Java application may therefore be loaded and installed, i.e. instantiated, onto the card by means of OTA—Over-the-Air—scheme. The Java application, which supports the functionalities mentioned above and other functionalities that will be described here-after may be rendered operational in the SIM cards through a two-steps scheme.

Specifically, the developed Java application may first be installed on the SIM, either in factory during personalization step or via OTA scheme while the SIM cards are on the field. Thereafter, in a second and decorrelated step, a PUSH command may be sent from a server to all the SIMs of the existing end-users in the operator's network. The new service is thereby introduced as well as its price. Should the end-user opt for such service and proceed to payment thereof, then the Java application which exists in the card but is not active may be rendered active though OTA means, i.e. instantiated through purposeful over-the-air commands.

The functionalities of the Java application in the present embodiment will be more precisely described hereafter. Although described as performed by a sole application, those different functionalities may alternately be split between different software entities, and preferably in the SIM card.

In the present case, the above described protective functionality as performed by the Java application is not actuated simply by triggering a view entry on the screen of the mobile phone.

Some service information is displayed instead of a “VIEW” button, for example such service information as “Your balance has little money, please recharge in time.”

When recognizing this pre-defined service information, the end-user deduces that a message is received and the end-user may attempt to view the original received content easily by inputting correct pin code. The service information hence acts like an invitation for typing the PIN-code, while the people around the end-user do only interpret this service information as deprived of any other meaning than the service itself it seems to refer to. At this step the end-user has the choice to type his PIN code and display the received message or to play as though no further message was proposed other than the service information.

Other people around, or otherwise people having the mobile phone of the end-user in hand, are thus not tempted to investigate further so as to know the end-user has received a message that may interest them. The displayed service information only refers in their mind to the related service, here a “balance of money” service.

The content of the received short message is restored on the screen of the mobile phone when the end-user types his PIN-code, as depicted on FIG. 2. Then the truly received SMS appears on the screen of the mobile phone, as depicted on FIG. 3, which in this case is an SMS informing the end-user of a new password for a specific access such as an online test in the present example.

It should be noted that the replacing message, i.e. the mask message, may, in a first embodiment, pop-up directly onto the screen of the end-user as soon as the hidden message has been received, or may, in a second embodiment, appear as though it was the true content of a received message.

In this second embodiment, an icon is first displayed on the screen of the mobile phone, indicating that a new message has been received. Then the end-user triggers the message display functionality of his mobile phone, and an SMS content appears on the screen of the mobile phone, which seems to be the true content as has been received. Actually the displayed content is the replacing content as replaced by means of the Java application and thereby masking the content of the truly received message. The end-user then has the opportunity to type his PIN-code for the replacing message to disappear in favor of the true received message.

In this case, the Java application is triggered by events such as a kind of “read message” event as sent from mobile terminal 10 to card 20.

The Java application is first proposed to the end-user through a specific message, which is directed to the end-user in response to an event sent to the SIM card after the Java application has been installed.

Information about proposed protection of incoming SMSs may be pushed to users with the following text, in accordance with FIG. 4:

“A new service to protect your private short message named Mask Your SMS is available now. It can mask your short messages by displaying any text info defined by you. For example, “Your balance has little money, please recharge in time.” Do you want to install this service right now? Just 1$ for Mask Your SMS.”

Let's assume that the user has selected this service and the installation process has been completed via OTA.

As represented on FIGS. 5 and 6, the Java application then offers the end-user the possibility to set his PIN code and to choose the service message which is going to be displayed onto the screen of his mobile.

After such actuating steps, people can view what seems to be a received message without being inquired any pin code, but what they can see is just the “Mask Text” as displayed on FIG. 7. In this way, the original message is hidden by the “Mask Text” and therefore received messages can no more be viewed by anyone.

Although described as performed by an application hosted in the SIM card, the technical aspects described may as well be implemented in a mobile terminal assembly, which comprises a mobile terminal and optionally a SIM card. Those technical aspects may hence be implemented by means of a processor and a memory of a mobile terminal itself.

1. A mobile terminal assembly (10,20) in a mobile communication network, said mobile terminal assembly (10,20) comprising a processor and a memory and hosting software which controls, after an original message has been received, the following steps: a) display on the mobile terminal assembly (10,20) a pre-defined content which the end-user previously knows as meaning that a PIN code is expected, b) expect input of a PIN code, and c) allow access to content of the original message when the end-user has input the expected PIN code.

2. The mobile terminal assembly (10,20) according to claim 1, further comprising a personal token (20) and the software is stored and run in the personal token (20).

3. The mobile terminal assembly (10,20) according to claim 1, wherein the pre-defined content does not indicate that a PIN code is expected.

4 The mobile terminal assembly (10,20) according to claim 1, wherein the pre-defined content does not indicate that a received original message is available.

5. The mobile terminal assembly (10,20) according to anyone of the preceding claims, wherein the software implements functionality for the end-user to set the pre-defined content.

6. The mobile terminal assembly (10,20) according to claim 1, 2, 3, or 4, wherein the software implements functionality for the end-user to choose a PIN code.

7. The mobile terminal assembly (10,20) according to claim 1, 2, 3, or 4, comprising: a) functionality for indicating that an original new message is received;
b) functionality for possibly displaying content of the original new message, and, c) functionality for, in case a user actuates functionality for displaying content of the original new message, displaying the pre-defined content in place of the content of the original new message so that the predefined content appears as though it was the content of the original message.

8. A personal token (20) to be hosted in a mobile terminal in a mobile communication network, said personal token (20) comprising a processor and a memory and hosting software which controls, after an original message has been received, the following steps: a) display on the mobile terminal assembly (10,20) a pre-defined content which the end-user previously knows as meaning that a PIN code is expected, b) expect input of a PIN code, and c) allow access to content of the original message when the end-user has input the expected PIN code.

9. The personal token (20) according to claim 8, wherein the pre-defined content does not indicate by itself that a PIN code is expected.

10. The personal token (20) according to claim 8, wherein the pre-defined content does not does not indicate that a protected message content is available.

11. The personal token (20) according to anyone of claims 8-10, wherein the software implements functionality for the end-user to set the pre-defined content.

12. The personal token (20) according to anyone of claims 8-10, wherein software implements functionality for the end-user to choose his PIN code.

13. The personal token (20) according to anyone of claims 8-10, comprising: a) functionality for indicating that an original new message is received;
b) functionality for possibly displaying content of the original new message, and, c) functionality for, in case a user actuates functionality for displaying content of the original new message, displaying the pre-defined content in place of the content of the original new message so that the predefined content appears as though it was the content of the original message.
